(19) United States
(12) Patent Application Publication
(10) Pub. No.: US 2021/0269356 A1
(43) Pub. Date: Sep. 2, 2021

(54) GLASS ARTICLE AND METHOD FOR MANUFACTURING THE SAME

(71) Applicant: Samsung Display Co., Ltd., Yongin-si (KR)

(72) Inventors: Byung Hoon KANG, Hwaseong-si (KR); Seung KIM, Seongnam-si (KR); Young Ok PARK, Hwaseong-si (KR); Su Jin SUNG, Hwaseong-si (KR); Gyu In SHIM, Yongin-si (KR)

(21) Appl. No.: 17/031,641

(22) Filed: Sep. 24, 2020

(30) Foreign Application Priority Data
Feb. 27, 2020 (KR) 10-2020-0024226

(51) Int. Cl. C03C 21/00; C03C 3/083; C03C 4/18

(52) U.S. Cl. CPC C03C 21/002; C03C 2204/00; C03C 4/18; C03C 3/083

(57) ABSTRACT

A method for manufacturing a glass article for a display device includes: providing a LAS-based glass; a first step of immersing the LAS-based glass in a first molten salt; a second step of immersing the LAS-based glass subjected to the first step in a second molten salt; and a third step of immersing the LAS-based glass subjected to the second step in a third molten salt, wherein the concentrations of the first, second, and third molten salts and manufacturing conditions are defined herein.

### CROSS-REFERENCE TO RELATED APPLICATION

This application claims priority from and the benefit of Korean Patent Application No. 10-2020-0024226 filed on Feb. 27, 2020, which is hereby incorporated by reference for all purposes as if fully set forth herein.

### BACKGROUND

### Field

Exemplary embodiments of the invention relate generally to a glass article for a display device and a method for manufacturing the same.

### Discussion of the Background

### Description of the Related Art

Glass articles are widely used in electronic devices or construction materials including display devices. For example, a glass article is applied to a substrate of a flat panel display device such as an organic light emitting display (OLED), a micro-LED display, a nano-LED display, a quantum dot light emitting display, a liquid crystal display, a plasma display, a field emission display, an electrophoretic display and an electrowetting display, or a window for protecting it.

As portable electronic devices such as smart phones and tablet PCs have become popular, glass articles used therein are frequently exposed to external impacts. Accordingly, it is preferable to apply a glass article that is thin for portability of such electronic devices and has good strength to withstand external impacts.

The above information disclosed in this Background section is only for understanding of the background of the inventive concepts, and, therefore, it may contain information that does not constitute prior art.

### SUMMARY

Glass articles constructed according to the principles and exemplary embodiments of the invention and methods of manufacturing the same have good strength to withstand external impacts.

Additional features of the inventive concepts will be set forth in the description which follows, and in part will be apparent from the description, or may be learned by practice of the inventive concepts.

According to one aspect of the invention, a method for manufacturing a glass article for a display device includes: providing a LAS-based glass; a first step of immersing the LAS-based glass in a first molten salt; a second step of immersing the LAS-based glass subjected to the first step in a second molten salt; and a third step of immersing the LAS-based glass subjected to the second step in a third molten salt, wherein a concentration in the first molten salt of first cations ranges from about 75 mol % to about 25 mol %, and a concentration of second cations ranges from about 25 mol % to about 75 mol %, based on the total number of moles of cations in the first molten salt, wherein a concentration in the second molten salt of first cations ranges from about 5 mol % to about 10 mol %, and a concentration of second cations ranges from about 90 mol % to about 95 mol %, based on the total number of moles of cations in the second molten salt wherein a concentration in the third molten salt of second cations ranges from about 99.5 mol % to about 100 mol % based on the total number of moles of cations in the third molten salt, and wherein the third step is performed for about 5 minutes to about 10 minutes.

The first cations may have a size smaller than that of the second cations.

The first cations may include sodium ions, and the second cations may include potassium ions.

The first step may include a first strengthening step performed for about 90 minutes to about 240 minutes at a temperature of about 385° C. to about 405° C.

The second step may include a second strengthening step performed for about 30 minutes to about 120 minutes at a temperature of about 370° C. to about 390° C.

The third step may include a third strengthening step performed at a temperature of about 370° C. to about 390° C.

Each of the first molten salt and the second molten salt may include at least one of sodium nitrate and potassium nitrate, and wherein the third molten salt may include potassium nitrate.

The LAS-based glass subjected to the first to third steps may have a maximum compressive stress in a range of about 986.6 MPa to about 1248.1 MPa.

The strengthened LAS-based glass may have a stress profile including at least four inflection points.

The strengthened LAS-based glass may have a compression depth of about 120 μm to about 130 μm.

The strengthened LAS-based glass may have an average value of a critical drop height, which ranges from about 70 cm to about 100 cm, in a glass impact test (GIT) evaluation using a ball of 60 g for 10 or more samples.

The LAS-based glass may include a silicon dioxide in a range of about 55 mol % to about 62 mol %, an aluminum oxide in a range of about 18 mol % to about 26 mol %, a sodium oxide in a range of about 8 mol % to about 13 mol %, and a lithium oxide in a range of about 2 mol % to about 5 mol %; based on oxide.

The third molten salt may be used multiple times, and the third step may further include replacing the third molten salt about every 30 times of repeated use.

According to another aspect of the invention, a glass article for a display device, the glass article contains lithium aluminosilicate and includes: a first surface; a second surface opposed to the first surface; a first compressive region extending from the first surface to a first compression depth; a second compressive region extending from the second surface to a second compression depth; and a tensile region disposed between the first compression depth and the second compression depth, wherein the first compressive region has a stress profile including a first segment located between the first compression depth and a first transition point, a second segment located between the first transition point and a first′ transition point, and a third segment located between the first′ transition point and the first surface, wherein the first surface has a stress ranging from about 986.6 MPa to about 1248.1 MPa, wherein the first compression depth ranges from about 120 μm to about 140 μm, wherein a depth from the first surface to the first transition point ranges from about 9.5 μm to about 10.5 μm, and wherein at the first transition point has a stress ranging from about 70 MPa to about 150 MPa.

The depth from the first surface to the first′ transition point may be about 9.5 μm or less, and wherein the first′ transition point may have a stress ranging from about 150 MPa to about 1000 MPa.

The depth of the first transition point may be about 0.075 times to about 0.084 times the first compression depth.

The stress at the first transition point may be about 0.08 times to about 0.12 times the stress at the first surface.

The absolute value of an average slope of the second segment may be greater than an absolute value of an average slope of the first segment, and wherein an absolute value of an average slope of the third segment may be greater than the absolute value of the average slope of the second segment.

The absolute value of the average slope of the first segment may have a value in a range of about 0.9 to about 1.05, wherein the absolute value of the average slope of the second segment may have a value in a range of about 1.05 to about 93, and wherein the absolute value of the average slope of the third segment may have a value greater than about 93.

The glass article may have an average value of a critical drop height, which may range from about 70 cm to about 100 cm, in a glass impact test (GIT) evaluation using a ball of 60 g for 10 or more samples.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the inventive concepts.

FIG. 1 is a perspective view of exemplary embodiments of a glass article constructed according to principles of the invention.

FIG. 2 is a cross-sectional view illustrating an exemplary embodiment of a glass article constructed according to principles of the invention used as a cover window of a display device.

FIG. 3 is a cross-sectional view of the glass article of FIG. 2, which has a generally, flat plate shape.

FIG. 4 is a graphical depiction showing a stress profile of an exemplary embodiment of a glass article constructed according to principles of the invention.

FIG. 5 is an enlarged graphical depiction of the vicinity of the first compressive region of FIG. 4.

FIG. 6 is a graphical depiction approximating the stress profile of FIG. 5.

FIG. 7 is a flowchart of an exemplary embodiment of a method for manufacturing a glass article according to principles of the invention.

FIG. 8 is a schematic diagram illustrating an exemplary embodiment of an ion exchange process of a first strengthening step in the method for manufacturing the glass article of FIG. 7.

FIG. 9 is a graphical depiction showing the stress profile of the glass article after having undergone the first strengthening step.

FIG. 10 is a schematic diagram illustrating an exemplary embodiment of an ion exchange process of a second strengthening step in the method for manufacturing the glass article of FIG. 7.

FIG. 11 is a graphical depiction showing the stress profile of the glass article after having undergone the second strengthening step.

FIG. 12 is a schematic diagram illustrating an exemplary embodiment of an ion exchange process of a third strengthening step in the method for manufacturing the glass article of FIG. 7.

FIG. 13 is a graphical depiction showing the maximum compressive stress of a glass article changing over time during the ion exchange process of the third strengthening step.

FIG. 14 is a graphical depiction showing glass impact test (GIT) results of a glass article with and without applying the third strengthening step.

### DETAILED DESCRIPTION OF THE EMBODIMENTS

In the following description, for the purposes of explanation, numerous specific details are set forth in order to provide a thorough understanding of various exemplary embodiments or implementations of the invention. As used herein “embodiments” and “implementations” are interchangeable words that are non-limiting examples of devices or methods employing one or more of the inventive concepts disclosed herein. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an exemplary embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various exemplary embodiments are described herein with reference to sectional and/or exploded illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

As used herein, the term “glass article” refers to an article made entirely or partially of glass, which is usually an amorphous undercooled liquid of extremely high viscosity that appears as a solid, and may include one or more nonmetallic elements, e.g., silicon, and metallic elements, e.g., calcium, lead, lithium, sodium, rubidium, cesium and/or potassium, in the form of oxides, such as silicon dioxide. An exemplary glass is a lithium aluminosilicate glass, and may be referred to herein as a “LAS-based glass”.

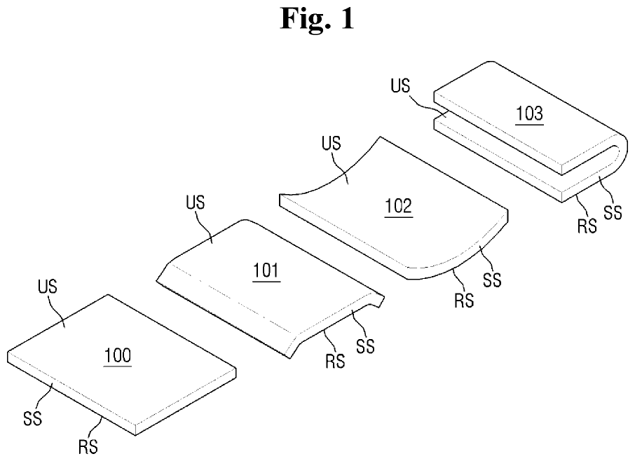

FIG. 1 is a perspective view of exemplary embodiments of a glass article constructed according to principles of the invention.

Glass is used as a cover window for protecting a display, a substrate for a display panel, a substrate for a touch panel, an optical member such as a light guide plate and the like in electronic devices including a display, such as a tablet PC, a notebook PC, a smart phone, an electronic book, a television and a PC monitor as well as a refrigerator and a cleaning machine including a display screen. Glass may also be employed as a cover glass for a dashboard of a vehicle, a cover glass for solar cells, interior materials for construction materials, windows for buildings and houses, and the like.

Some glass articles are required to have high strength. For example, when glass is employed as a window, it is desirable to have a small thickness to meet the requirements of high transmittance and lightweightness, and also have strength such that it is not easily broken by an external impact. Strengthened glass can be produced by, for example, chemical strengthening or thermal strengthening. Examples of strengthened glass having various shapes are shown in FIG. 1.

Referring to FIG. 1, in an exemplary embodiment, a glass article 100 may have a generally flat sheet shape or a generally flat plate shape. In another exemplary embodiment, glass articles 101, 102 and 103 may have a three-dimensional shape including bent portions. For example, the edges of the flat portion may be bent (e.g., the glass article 101), or the flat portion may be entirely curved (e.g., the glass article 102) or folded (e.g., the glass article 103).

The generally planar shape of the glass articles 100 to 103 may be a generally rectangular shape, but is not limited thereto, and may have various shapes such as a generally rectangular shape with rounded corners, a generally square shape, a generally circular shape, and a generally elliptical shape. In the following exemplary embodiments, a generally flat plate having a generally rectangular planar shape is described as an example of the glass articles 100 to 103, but the exemplary embodiments are not limited thereto.

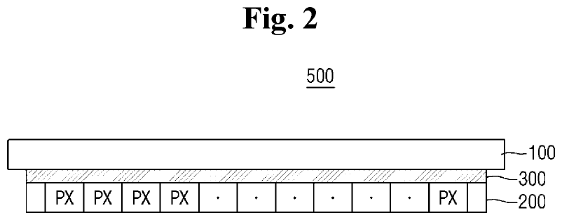

FIG. 2 is a cross-sectional view illustrating an exemplary embodiment of a glass article constructed according to principles of the invention used as a cover window of a display device.

Referring to FIG. 2, a display device 500 may include a display panel 200, a cover window 100 disposed on the display panel 200, and an optically transparent bonding layer 300 disposed between the display panel 200 and the cover window 100 to bond the display panel 200 and the cover window 100 to each other.

Examples of the display panel 200 may include not only a self-luminous display panel such as an organic light emitting display (OLED) panel, an inorganic electroluminescence (EL) display panel, a quantum dot (QED) display panel, a micro-LED display panel, a nano-LED display panel, a plasma display panel (PDP), a field emission display (FED) panel and a cathode ray tube (CRT) display panel, but also a light receiving display panel such as a liquid crystal display (LCD) panel and an electrophoretic display (EPD) panel, and any other known display panel.

The display panel 200 includes a plurality of pixels PX and may display an image by using light emitted from each pixel PX. The display device 500 may further include a touch member. In an exemplary embodiment, the touch member may be embedded in the display panel 200. For example, since the touch member is directly formed on a display member of the display panel 200, the display panel 200 itself may perform a touch function. In another exemplary embodiment, the touch member may be manufactured separately from the display panel 200 and then attached to the top surface of the display panel 200 by an optically transparent bonding layer.

The cover window 100 is disposed on the display panel 200. The cover window 100 serves to protect the display panel 200. The strengthened glass article 100 may be used as a main body of the cover window 100. Because the cover window 100 is larger in size than the display panel 200, the side surface SS thereof may protrude outward from the side surface SS of the display panel 200, but it is not limited thereto. The cover window 100 may further include a print layer disposed on at least one surface of the glass article 100 at an edge portion of the glass article 100. The print layer of the cover window 100 may prevent the bezel area of the display device 500 from being visible from the outside, and may perform a decoration function in some cases. The optically transparent bonding layer 300 is disposed between the display panel 200 and the cover window 100. The optically transparent bonding layer 300 serves to fix the cover window 100 onto the display panel 200. The optically transparent bonding layer 300 may include an optically clear adhesive (OCA), an optically clear resin (OCR), or the like. Hereinafter, the strengthened glass article 100 will be described in more detail.

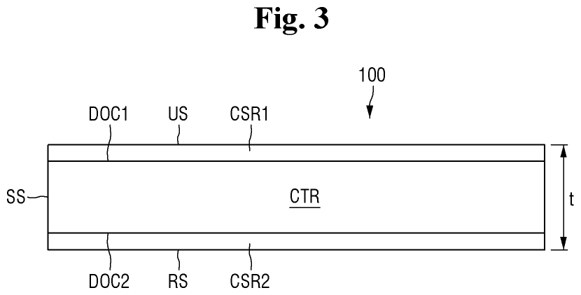

FIG. 3 is a cross-sectional view of the glass article of FIG. 2, which has a generally, flat plate shape.

Referring to FIG. 3, the glass article 100 may include a first surface US, a second surface RS and a side surface SS. In the glass article 100 having a generally flat plate shape, the first surface US and the second surface RS are main surfaces having a large area, and the side surface SS is an outer surface connecting the first surface US with the second surface RS in the thickness direction.

Thus, the first surface US and the second surface RS are opposed to each other in the thickness direction. When the glass article 100 is used to transmit light in the same manner as the cover window 100 of the display device 500, the light may be mainly incident on one of the first surface US and the second surface RS and pass through the other one.

The thickness t of the glass article 100 is defined as a distance between the first surface US and the second surface RS. The thickness t of the glass article 100 may range, but is not limited to, from about 0.1 to about 2 mm. In an exemplary embodiment, the thickness t of the glass article 100 may be about 0.8 mm or less. In another exemplary embodiment, the thickness t of the glass article 100 may be about 0.75 mm or less. In yet another exemplary embodiment, the thickness t of the glass article 100 may be about 0.7 mm or less. In yet another exemplary embodiment, the thickness t of the glass article 100 may be about 0.6 mm or less. In yet another exemplary embodiment, the thickness t of the glass article 100 may be about 0.65 mm or less. In yet another exemplary embodiment, the thickness t of the glass article 100 may be about 0.5 mm or less. In yet another exemplary embodiment, the thickness t of the glass article 100 may be about 0.3 mm or less. In some particular exemplary embodiments, the thickness t of the glass article 100 may range from about 0.45 mm to about 0.8 mm or from about 0.5 mm to about 0.75 mm. The glass article 100 may have a uniform thickness t, but is not limited thereto and may have a different thickness t for each region.

The glass article 100 may be strengthened to have a predetermined stress profile therein. The strengthened glass article 100 more efficiently prevents generation of cracks, propagation of cracks, breakage and the like due to external impact than the glass article 100 before strengthening. The glass article 100 strengthened by a strengthening process may have a different stress for each region. For example, compressive regions CSR1 and CSR2 to which a compressive stress is applied may be disposed in the vicinity of the surface of the glass article 100, i.e., near the first surface US and the second surface RS, and a tension region CTR to which a tensile stress is applied may be disposed inside the glass article 100. The boundary between the compressive region CSR1, CSR2 and a tensile region CTR may have a stress value of zero. The compressive stress in one compressive region CSR1, CSR2 may have a different stress value depending on the position (i.e. depth from the surface). Also, the tensile region CTR may have a different stress value depending on the depth from the first surface US and second surface RS. The position of the compressive region CSR1, CSR2, the stress profile in the compressive region CSR1, CSR2, the compressive energy of the compressive region CSR1, CSR2, the tensile energy of the tensile region CTR or the like in the glass article 100 has a great influence on the mechanical properties of the glass article 100 such as the surface strength. A detailed description thereof is provided below. Hereinafter, the stress profile of the strengthened glass article 100 will be described in detail.

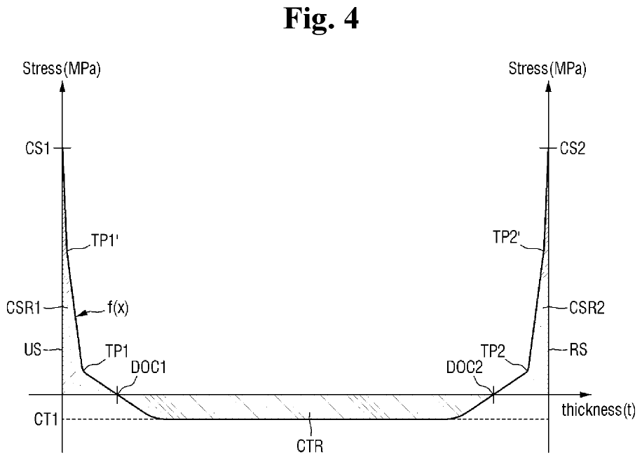

FIG. 4 is a graphical depiction showing a stress profile of an exemplary embodiment of a glass article constructed according to principles of the invention.

In the graph of FIG. 4, an X-axis represents the thickness direction of the glass article 100. In FIG. 4, the compressive stress has positive values, while the tensile stress has negative values. Herein, the magnitude of the compressive and tensile stress means the magnitude of an absolute value regardless of its sign.

Referring to FIG. 4, the glass article 100 includes a first compressive region CSR1 extending (or expanding) from the first surface US to a first compression depth DOL1, and a second compressive region CSR2 extending (or expanding) from the second surface RS to a second compression depth DOL2. The tensile region CTR is disposed between the first compression depth DOL1 and the second compression depth DOL2. The overall stress profile in the glass article 100 may be substantially symmetrical between both regions of the surfaces US and RS with respect to the center of the direction of the thickness t. A compressive region and a tensile region may be disposed between opposed side surfaces SS of the glass article 100 in a similar manner.

The first compressive region CSR1 and the second compressive region CSR2 are resistant to an external impact to prevent the occurrence of cracks or breakage of the glass article 100. As the maximum compressive stresses CS1 and CS2 of the first compressive region CSR1 and the second compressive region CSR2 are larger, the strength of the glass article 100 generally increases. Because an external impact is usually transmitted through the surface of the glass article 100, it is advantageous to have the maximum compressive stresses CS1 and CS2 at the surface of the glass article 100 in terms of durability. From this perspective, the compressive stress of the first compressive region CSR1 and the second compressive region CSR2 tends to be the largest at the surface and generally decrease toward the inside.

The first compression depth DOL1 and the second compression depth DOL2 suppress cracks or grooves formed in the first surface US and the second surface RS from propagating to the tensile region CTR inside the glass article 100. As the first compression depth DOL1 and the second compression depth DOL2 are larger, it is possible to more efficiently prevent propagation of cracks and the like. The point corresponding to the first compression depth DOC1 and the second compression depth DOC2 corresponds to a boundary between the compressive regions CSR1 and CSR2 and the tension region CTR, and has a stress value of zero.

Throughout the glass article 100, the tensile stress of the tensile region CTR may be balanced with the compressive stress of the compressive regions CSR1 and CSR2. That is, the total compressive stress (i.e., the compressive energy) in the glass article 100 may be the same as the total tensile stress (i.e., the tensile energy) in the glass article 100. The stress energy accumulated in one region having a constant width in the thickness t direction in the glass article 100 may be calculated as an integrated value of the stress profile. The following relational expression may be established when the stress profile in the glass article 100 having a thickness t represented as a function f(x).

∫₀^{t}f(x)dx=0 Mathematical Expression 1

The greater the magnitude of the tensile stress in the glass article 100, the more likely the fragments are to be vigorously released when the glass article 100 is broken, and the more likely the glass article 100 is to be broken from the inside. The maximum tensile stress that meets the frangibility requirements of the glass article 100 may satisfy, but not limited to, the following relationship:

CT₁≤−38.7×ln(t)+48.2 Mathematical Expression 2

In some exemplary embodiments, the maximum tensile stress CT1 may be about 90 MPa or less, or about 75 MPa or less. The maximum tensile stress CT1 of about 60 MPa or more may be desirable to improve mechanical properties such as strength. In an exemplary embodiment, the maximum tensile stress CT1 may be greater than or equal to about 60 MPa and less than or equal to about 75 MPa, but is not limited thereto.

The maximum tensile stress CT1 of the glass article 100 may be generally located at a central portion in the thickness t direction of the glass article 100. For example, the maximum tensile stress CT1 of the glass article 100 may be located at a depth in the range of about 0.4t to about 0.6t, or in the range of about 0.45t to about 0.55t, or at a depth of about 0.5t.

In order to increase the strength of the glass article 100, it is preferable that the compressive stress and the compression depths DOC1 and DOC2 have large values. However, as the compressive energy increases, the tensile energy also increases, and the maximum tensile stress CT1 may increase. In order to meet the fragility requirements while having high strength, it is desirable to adjust the stress profile such that the maximum compressive stresses CS1 and CS2 and the compression depths DOL1 and DOL2 have large values while the compressive energy becomes smaller. To this end, the first compressive region CSR1 and the second compressive region CSR2 may include first and second transition points TP1 and TP2 and first′ and second′ transition points TP1′ and TP2′, respectively, at which the slope of the stress profile changes abruptly. The shape of the stress profile (particularly, the shape of the stress profile in the compressive region) can be precisely controlled by adjusting the process conditions of a first ion exchange process and a second ion exchange process.

Hereinafter, a detailed description of the stress profile of the compressive region will be given with reference to FIG. 4. The following description will focus on the stress profile of the first compressive region CSR1, and since the first compressive region CSR1 and the second compressive region CSR2 have a substantially symmetrical relationship in the stress profile, a repeated description of the stress profile of the second compressive region CSR2 will be omitted or simplified to avoid redundancy.

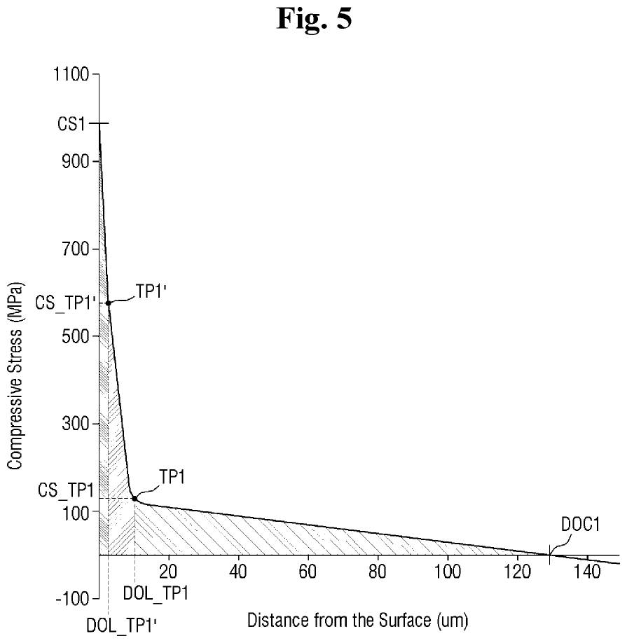

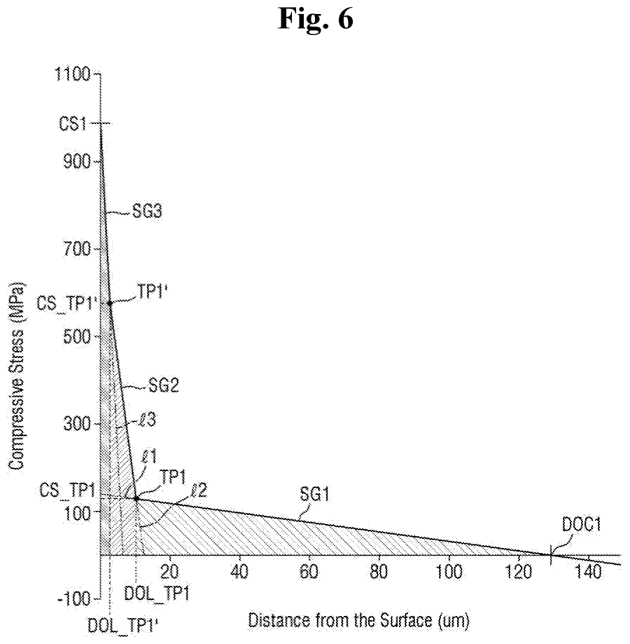

FIG. 5 is an enlarged graphical depiction of the vicinity of the first compressive region of FIG. 4. FIG. 6 is a graphical depiction approximating the stress profile of FIG. 5.

Referring to FIGS. 5 and 6, the stress profile in the first compressive region CSR1 has a negative slope and generally decreases as it goes from the first surface US to the first compression depth DOC1. The stress profile in the first compressive region CSR1 may include at least two transition points, such as first transition point TP1 (or inflection point) and first′ transition point TP1′, at which the slope changes abruptly.

The first transition point TP1 and the first′ transition point TP1′ may be located between the first surface US and the first compression depth DOC1. With regard to the first transition point TP1 and the first ‘transition point TP1’, the first transition point TP1 may be located near the first compression depth DOC1, and the first′ transition point TP1′ may be located near the first surface US. That is, the first transition point TP1 may be located between the first′ transition point TP1′ and the first compression depth DOC1, and the first′ transition point TP1′ may be located between the first transition point TP1 and the first surface US.

The stress profile in the first compressive region CSR1 may be divided into a first segment SG1, a second segment SG2 and a third segment SG3 based on the first transition point TP1 and the first′ transition point TP1′. That is, the stress profile in the first compressive region CSR1 may include the first segment SG1 extending from the first compression depth DOC1 to the first transition point TP1, the second segment SG2 extending from the first transition point TP1 to the first′ transition point TP1′, and the third segment SG3 extending from the first′ transition point TP1′ to the first surface US.

The first segment SG1 and the second segment SG2 may be divided by the type of ions penetrated. For example, potassium (K) ions may penetrate only into a depth section of the second segment SG2 and the third segment SG3 located relatively near to the first surface US, and may not substantially penetrate into a depth section of the first segment SG1 located relatively inward in the first compressive region CSR1. On the other hand, sodium (Na) ions having an ion size smaller than potassium (K) ions may penetrate not only into the depth section of the third segment SG3 and the second segment SG2 but also into the depth section of the first segment SG1. The first transition point TP1 may correspond to the maximum penetration depth of potassium (K) ions.

The second segment SG2 and the third segment SG3 may be divided by a change in the slope of the stress profile. Specifically, the third segment SG3 may have a larger slope and the second segment SG2 may have a smaller slope based on the first′ transition point TP1′ at which the slope changes abruptly.

The stress of the second segment SG2 and the third segment SG3 in the first compressive region CSR1 may be mainly determined by the density of potassium (K) ions. As described above, the second segment SG2 and the third segment SG3 may further include sodium (Na) ions, but the stress of the section may depend mainly on the density of potassium (K) ions having a larger ion size. In the depth section of the second segment SG2 and the third segment SG3, the greater the density of potassium (K) ions, the higher the stress, and the stress profile may substantially approximate to the density profile of potassium (K) ions. Even in the density profile of potassium (K) ions, the slope of the density profile may change abruptly based on the first′ transition point TP1′, and the density of potassium (K) ions in the third segment SG3 may be greater than the density of potassium (K) ions in the second segment SG2.

As described above, since the first segment SG1 in the first compressive region CSR1 is located more inward than the first transition point TP1, which is the maximum penetration depth of potassium (K) ions, the stress of the first segment SG1 may be determined mainly by the density of sodium (Na) ions. That is, in the depth section of the first segment SG1, the greater the density of sodium (Na) ions, the higher the stress, and the stress profile may substantially approximate to the density profile of sodium (Na) ions. The first compression depth DOC1 may substantially correspond to the maximum penetration depth of sodium (Na) ions.

The first segment SG1 may substantially approximate a first straight line l1 connecting the coordinates of the first transition point TP1 and the coordinates of the first compression depth DOC1 in the corresponding section. The first straight line l1 may be expressed as a first function in Mathematical Expression 3 below in a coordinate plane with an X-axis indicating depth and a Y-axis indicating stress.

y=m₁x+a Mathematical Expression 3

where m₁ is a first slope of the first straight line l1, a represents a y-intercept, and −a/m₁ is an x-intercept, which represents the first compression depth DOC1.

Some sections of the tensile region CTR adjacent to the first compressive region CSR1 may have a stress profile in conformity with the first straight line l1. In one exemplary embodiment, the absolute value of m₁ may have a value ranging from about 0.9 to about 1.05. In another exemplary embodiment, the absolute value of m₁ may have a value ranging from about 0.95 to about 1.00, but is not limited thereto.

The second segment SG2 may substantially approximate a second straight line l2 connecting the coordinates of the first transition point TP1 and the coordinates of the first′ transition point TP1′ in the corresponding section. The second straight line l2 may be expressed as a second function in Mathematical Expression 4 below in a coordinate plane with an X-axis indicating depth and a Y-axis indicating stress.

y=m₂x+b Mathematical Expression 4

where m₂ is a second slope of the second straight line l2, and b represents an intercept.

In one exemplary embodiment, the absolute value of m₂ may be about 93 or less. In another exemplary embodiment, the absolute value of m₂ may be about 80 or less. In still another exemplary embodiment, the absolute value of m₂ may be about 70 or less, but is not limited thereto.

The third segment SG3 may substantially approximate to a third straight line l3 connecting the coordinates of the first′ transition point TP1′ and the coordinates of the compressive stress CS1 at the first surface US in the corresponding section. The third straight line l3 may be expressed as a third function in Mathematical Expression 5 below in a coordinate plane with an X-axis indicating depth and a Y-axis indicating stress.

y=m₃x+c Mathematical Expression 5

where m₃ is a third slope of the third straight line l3, and c is a y-intercept, which represents the compressive stress CS1 at the first surface US.

In one exemplary embodiment, the absolute value of m₃ may be about 93 or more. In another exemplary embodiment, the absolute value of m₃ may be about 100 or more. In still another exemplary embodiment, the absolute value of m₃ may be about 120 or more, but is not limited thereto.

In the above functions, each of the first slope m₁ to the third slope m₃ has a negative value, and the absolute value of the third slope m₃ of the third straight line l3 is greater than the absolute value of the second slope m₂ of the second straight line l2. The absolute value of the second slope m₂ of the second straight line l2 is greater than the absolute value of the first slope m₁ of the first straight line l1. The first segment SG1 may substantially have the first slope m₁, the second segment SG2 may substantially have the second slope m₂, and the third segment SG3 may substantially have the third slope m₃. That is, the absolute value of the average slope of the second segment SG2 may be greater than the absolute value of the average slope of the first segment SG1, and the absolute value of the average slope of the third segment SG3 may be greater than the absolute value of the average slope of the second segment SG2. In an exemplary embodiment, the absolute value of the average slope of the first segment SG1 may have a value ranging from about 0.9 to about 1.05, and the absolute value of the average slope of the second segment SG2 may have a value ranging from about 1.05 to about 93, and the absolute value of the average slope of the third segment SG3 may have a value greater than about 93.

The first segment SG1, the second segment SG2 and the third segment SG3 having different slopes may be generated by a plurality of ion exchange processes. The ion exchange process is a process of exchanging ions in glass with other ions. By performing the ion exchange process, the ions at or near the first surface US, second surface RS, and side surface SS of the glass can be replaced or exchanged with larger ions having the same valence or oxidation state. For example, when the glass contains monovalent alkali metal ions such as lithium (Li) ions, sodium (Na) ions, potassium (K) ions and rubidium (Rb) ions, the monovalent cations on the surface may be replaced by sodium (Na) ions, potassium (K) ions, rubidium (Rb) ions, or cesium (Cs) ions with a larger ionic radius.

The first segment SG1 may be generated through a first ion exchange process, the second segment SG2 may be generated through a second ion exchange process, and the third segment SG3 may be generated through a third ion exchange process.

More specifically, the first ion exchange process is a process of imparting the compression depths DOC1 and DOC2 to the glass, and is performed generally by exposing the glass to mixed molten salt containing potassium (K) ions and sodium (Na) ions. For example, for the first ion exchange process, the glass is immersed in a bath containing mixed molten salt in which potassium nitrate (KNO₃) and sodium nitrate (NaNO₃) are mixed. In the mixed molten salt, the content of potassium nitrate (KNO₃) may be similar to the content of sodium nitrate (NaNO₃). For example, the salt ratio of potassium nitrate (KNO₃) to sodium nitrate (NaNO₃) may be adjusted in the range of about 25:about 75 to about 75:about 25. In an exemplary embodiment, the salt ratio of potassium nitrate (KNO₃) to sodium nitrate (NaNO₃) in the mixed molten salt of the first ion exchange process may be about 50:about 50, but is not limited thereto.

The first ion exchange process may be performed in the temperature range of ±about 20° C. of a temperature about 50° C. lower than the glass transition temperature. For example, when the glass transition temperature is about 580° C., the first ion exchange process may be performed at a temperature of about 500° C. or more. The first ion exchange process time may range from about 3 hours to about 8 hours, but is not limited thereto.

Through the first ion exchange process, lithium (Li) ions/sodium (Na) ions which are small ions inside the glass are exchanged with sodium (Na) ions/potassium (K) ions which are larger ions in the molten salt, thereby increasing the concentration of sodium (Na) ions and/or potassium (K) ions in the glass. Since the molten salt is provided with lithium (Li) ions from the glass, the molten salt of the first bath after the first ion exchange process may further include lithium (Li) ions in addition to sodium (Na) ions and potassium (K) ions.

After the first ion exchange process and before the second ion exchange process, a stress relieving process (or annealing process) may be further performed. The stress relieving process may be performed at a temperature of about 500° C. or more for about 1 to about 3 hours. The stress relieving process may reduce the maximum compressive stress and allow the diffusion of sodium (Na) ions (and/or potassium (K) ions) into the glass to increase the compressive depth. The stress relieving process may be performed in air or liquid. The stress relieving process may be omitted.

Upon completion of the first ion exchange process (if a stress relieving process is added, when the stress relieving process is completed), a stress profile corresponding to the first straight line l1 is generated. That is, sodium (Na) ions and/or potassium (K) ions of the mixed molten salt are exchanged to penetrate into the glass, and then diffuse in the depth direction. Sodium (Na) ions generally diffuse to the first compression depth DOC1 to form the first compressive region CSR1 having a compressive stress from the first surface US to the first compressive depth DOC1. That is, the first compression depth DOC1 is determined by the first ion exchange process and/or the stress relieving process.

The density of diffusing ions is substantially inversely proportional to the diffusion distance. Because sodium (Na) ions and potassium (K) ions enter the glass through ion exchange from the surface of the glass and diffuse in the depth direction, the concentration of sodium (Na) ions and potassium (K) ions tends to substantially linearly decrease as it goes away from the first surface US of the glass. As a result, the stress profile has the largest stress value at the first surface US1 and decreases in the depth direction in the same manner as the first straight line l1.

In addition, the degree of diffusion of ions is inversely proportional to the size of ions. In other words, as the size of ions is smaller, more ions can diffuse. Therefore, when both sodium (Na) ions and potassium (K) ions penetrate into the glass through the first ion exchange process, sodium ions having a relatively small size may diffuse more readily and penetrate to a deeper level. Sodium (Na) ions may diffuse to the first compression depth DOC1, while potassium (K) ions may diffuse only to a depth smaller than or equal to the first transition point TP1.

As discussed above, the first compression depth DOC1 has a close correlation with the maximum diffusion depth of sodium (Na) ions, which are smaller ions that are ion-exchanged. The first compression depth DOC1 may be the same as the maximum diffusion depth of sodium (Na) ions, or may be located in the vicinity thereof even though there is a slight difference, and may be generally proportional to the maximum diffusion depth of sodium (Na) ions. As described above, the first ion exchange process and/or the stress relieving process is a process of forming a predetermined first compression depth DOC1 through sufficient diffusion, and is performed for a sufficiently long time such that ions can be sufficiently diffused.

As the ion diffusion increases, the compressive stress CS1 at the first surface US may decrease. The maximum compressive stress CS1 increases as the density of ions increases. Thus, if the same amount of ions enters the glass, the more the diffusion, the smaller the density and the smaller the compressive stress CS1 at the first surface US. As described above, since the first ion exchange process has limitations to increasing the compressive stress CS1 of the first surface US, the second ion exchange process is further performed after the first ion exchange process in order to form a greater surface compressive stress CS1.

The second ion exchange process is a process of increasing the surface compressive stress CS1 at the first surface US, and is generally performed by exposing it to mixed molten salt containing potassium (K) ions and sodium (Na) ions. For example, for the second ion exchange process, the glass that has undergone the first ion exchange process is immersed in a second bath containing mixed molten salt in which potassium nitrate (KNO₃) and sodium nitrate (NaNO₃) are mixed and the salt ratio is adjusted such that main ions penetrating into the glass are potassium (K) ions. That is, the content of potassium nitrate (KNO₃) in the second bath is greater than that in the first ion exchange process, and furthermore, the concentration of potassium nitrate (KNO₃) may be greater than that of sodium nitrate (NaNO₃). For example, the salt ratio of potassium nitrate (KNO₃) to sodium nitrate (NaNO₃) in the second bath may be adjusted in the range of about 90:about 10 to about 95:about 5. In an exemplary embodiment, the salt ratio of potassium nitrate (KNO₃) to sodium nitrate (NaNO₃) in the mixed molten salt of the second ion exchange process may be about 92:about 8, but is not limited thereto.

The second ion exchange process may be performed at a lower temperature and for a shorter time than the first ion exchange process. For example, the second ion exchange process may be performed for about 1 hour to about 3 hours, or about 1.3 hours to about 2 hours in the temperature range of about 380° C. to about 460° C.

Through the second ion exchange process, it is possible to significantly increase the compressive stress in a shallow depth section from the glass surface US. Specifically, when potassium (K) ions penetrate into the glass, the compressive stress of the corresponding site is increased by potassium (K) ions having a larger size than sodium (Na) ions. In one exemplary embodiment, the maximum compressive stress CS1 of the first surface US subjected to the second ion exchange process may have a value ranging from about 700 MPa to about 850 MPa. In another exemplary embodiment, the maximum compressive stress CS1 of the first surface US subjected to the second ion exchange process may have a value ranging from about 730 MPa to about 820 MPa. In still another exemplary embodiment, the maximum compressive stress CS1 of the first surface US subjected to the second ion exchange process may have a value ranging from about 760 MPa to about 790 MPa, but is not limited thereto.

Potassium (K) ions which penetrate into the glass diffuse in the depth direction. Compared with the first ion exchange process, potassium (K) ions have a slower diffusion rate than sodium (Na) ions, and the duration of the second ion exchange process is shorter than that of the first ion exchange process. Accordingly, the diffusion depth of potassium (K) ions diffused through the second ion exchange process may be much smaller than the first compression depth DOC1. The maximum diffusion depth of potassium (K) ions may be equal to or less than the first transition point TP1, as described above.

The stress profile formed through the second ion exchange process has substantially the same shape as the second straight line l2. The maximum compressive stress CS1 of the first surface US is increased through the second ion exchange process, while the penetration depth (or the first transition point TP1) of the potassium (K) ions is smaller than the first compressive depth DOC1. Thus, the absolute value of the second slope m₂ of the second straight line l2 is greater than the absolute value of the first slope m₁ of the first straight line l1. That is, the compressive stress profile may have a slope which is steep in the vicinity of the surface of the glass article 100, and become gentler toward the interior of the glass article 100.

If the second ion exchange process is performed with single molten salt including about 100 mol % of potassium nitrate (KNO₃) without sodium nitrate (NaNO₃), it will be possible to secure the maximum compressive stress CS1 having the larger value at the first surface US. However, if the second ion exchange process is performed with single molten salt of potassium nitrate (KNO₃), the dispersion of the maximum compressive stress CS1 of the glass article may increase. Therefore, the second ion exchange process is performed in mixed molten salt having a salt ratio of potassium nitrate (KNO₃) to sodium nitrate (NaNO₃) in the range of about 90:about 10 to about 95:about 5 as described above. In order to form the larger surface compressive stress CS1 on the first surface US, the third ion exchange process is further performed after the second ion exchange process.

The third ion exchange process is a process of increasing the maximum compressive stress CS1, and is generally performed by exposing the glass to single molten salt containing potassium (K) ions. For example, the glass subjected to the second ion exchange process is immersed in a third bath containing single molten salt containing potassium nitrate (KNO₃). The single molten salt included in the third bath may be substantially single molten salt of potassium nitrate (KNO₃) by adjusting the salt ratio of potassium nitrate (KNO₃) to other materials in the range of about 99.5:about 0.5 to about 100:about 0. That is, the content of potassium nitrate (KNO₃) in the molten salt used in the third ion exchange process may be greater than the content in the molten salt used in the second ion exchange process.

The third ion exchange process may be performed for a short time at a temperature similar to that of the second ion exchange process. For example, the third ion exchange process may be performed for about 5 minutes to about 10 minutes, about 6 minutes to about 9 minutes, or about 7 minutes to about 8 minutes in the temperature range of about 380° C. to about 460° C.

Through the third ion exchange process, it is possible to significantly increase the compressive stress in a very shallow depth section of the glass surface US. Specifically, when potassium (K) ions penetrate into the glass, the compressive stress in the corresponding portion becomes larger due to the potassium (K) ions having a larger size. However, since the potassium (K) ions penetrating through the third ion exchange process penetrate only to a very shallow depth section, an increase in compressive energy may be insignificant. Therefore, the tensile energy additionally formed according to Mathematical Expression 1 may also be insignificant.

In one exemplary embodiment, the maximum compressive stress CS1 of the first surface US subjected to the third ion exchange process may have a value ranging from about 900 MPa to about 1,200 MPa. In another exemplary embodiment, the maximum compressive stress CS1 of the first surface US subjected to the third ion exchange process may have a value ranging from about 1,000 MPa to about 1,100 MPa. In still another exemplary embodiment, the maximum compressive stress CS1 of the first surface US subjected to the third ion exchange process may have a value ranging from about 1,120 MPa to about 1,180 MPa, but is not limited thereto.

Potassium (K) ions penetrating the inside of the glass diffuse in the depth direction. As compared with the second ion exchange process, the duration of the third ion exchange process is shorter than that of the second ion exchange process. Thus, the diffusion depth of potassium (K) ions diffused through the third ion exchange process may be smaller than the diffusion depth of potassium (K) ions diffused through the second ion exchange process. The maximum diffusion depth of potassium (K) ions diffused through the third ion exchange process may be below the first′ transition point TP1′.

The stress profile formed by the potassium (K) ions additionally penetrated through the third ion exchange process has substantially the same shape as in the third straight line l1. The maximum compressive stress CS1 of the first surface US increases through the third ion exchange process, while the penetration depth (or the first′ transition point TP1′) of potassium (K) ions through the third ion exchange process is smaller than the penetration depth (or the first transition point TP1) of potassium (K) ions through the second ion exchange process. Thus, the absolute value of the third slope m₃ of the third straight line l3 may be greater than the absolute value of the second slope m₂ of the second straight line l2. That is, the compressive stress profile may have a slope which is steep in the vicinity of the surface of the glass article 100, and become gentler toward the interior of the glass article 100. The stress profile in the first compressive region CSR1 as described above may have at least fourth main feature points.

A first feature point is a point corresponding to the y-intercept of the third straight line l3, which corresponds to the maximum compressive stress CS1 of the first surface US. A second feature point corresponds to the x-intercept of the first straight line l1, and corresponds to the first compression depth DOC1. A third feature point is located at the first transition point TP1. A fourth feature point is located at the first′ transition point TP1′. The position of the feature point is a factor that substantially determines the stress profile. Because the stress profile between the first feature point and the fourth feature point approximates the third straight line l3, the stress profile between the third feature point and the fourth feature point approximates the second straight line l2, and the stress profile between the second feature point and the third feature point approximates the first straight line l1, when the first feature point, the second feature point, the third feature point and the fourth feature point are determined, the shape of the stress profile may also be determined.

The first feature point is a point located on the first surface US, and has an x-coordinate value of 0 and a y-coordinate value which corresponds to the maximum compressive stress CS1. The maximum compressive stress CS1 expressed by the first feature point is associated with the strength of the glass article 100. By increasing the maximum compressive stress CS1, it is possible to prevent the occurrence of cracks due to external impacts. The maximum compressive stress CS1 is mainly determined by the amount of potassium (K) ions exchanged in the third ion exchange process, and may have a certain relationship with the degree of diffusion after ion exchange.

The maximum compressive stress CS1 may be about 300 MPa or more. In various exemplary embodiments, the maximum compressive stress CS1 may be about 400 MPa or more, about 500 MPa or more, about 600 MPa or more, or about 700 MPa or more. In addition, the maximum compressive stress CS1 may be about 2,000 MPa or less. In various exemplary embodiments, the maximum compressive stress CS1 may be about 1,800 MPa or less, about 1,500 MPa or less, or about 1,350 MPa or less. In some exemplary embodiments, the maximum compressive stress CS1 may be in the range of about 1,000 MPa to about 1,250 MPa.

The second feature point is a point where the stress value is 0, and has a y-coordinate value of 0 and an x-coordinate value which corresponds to the first compression depth DOC1. The first compression depth DOC1 represented by the second feature point corresponds to the size (or width) of the first compressive region CSR1 of the glass article 100. By increasing the first compression depth DOC1, it is advantageous in preventing cracks from propagating to the tensile region CTR. From this perspective, the first compression depth DOC1 (i.e., the distance from the first surface US to the first compression depth DOC1) may be about 50 μm or more, about 80 μm or more, about 100 μm or more, or about 120 μm or more. On the other hand, if the first compression depth DOC1 is excessively large, the compressive energy and the tensile energy may be excessively large, which may cause failure in satisfying the frangibility requirements. From this perspective, the first compression depth DOC1 may be about 250 μm or less, about 200 μm or less, about 180 μm or less, about 150 μm or less, or about 140 μm or less. In some exemplary embodiments, the first compression depth DOC1 may range from about 120 μm to about 140 μm.

The first compression depth DOC1 may be controlled mainly by the temperature and time of the first ion exchange process and/or the stress relieving process. The first compression depth DOC1 may be about 0.1t or more, about 0.15t or more, or about 0.18t or more with respect to the thickness t of the glass. Further, the first compression depth DOC1 may be about 0.25t or less, about 0.23t or less, or about 0.2t or less with respect to the thickness t of the glass.

The third feature point is located at a predetermined depth and has a predetermined stress value. The first transition point TP1 represented by the third feature point is deeply associated with the first slope m₁ of the first segment SG1 and the second slope m₂ of the second segment SG2. The first slope m₁ may be determined by process conditions of the first ion exchange process and the stress relieving process, and the second slope m₂ may be determined by process conditions of the second ion exchange process.

The x-coordinate value (depth) of the first transition point TP1 has a value between 0 and the first compression depth DOC1, and the y-coordinate value (stress) of the first transition point TP1 has a value between 0 and the maximum compressive stress CS1. According to the above-described example of the first compression depth DOC1 and the maximum compressive stress CS1, the position of the first transition point TP1 determines the general shape of the stress profile in the first compressive region CSR1. In addition, the position of the first transition point TP1 determines the area of the first compressive region CSR1, i.e., the magnitude of the compression energy.

If a depth DOL_TP1 of the first transition point TP1 is excessively large, the manufacturing cost may increase, the magnitude of compressive energy may be excessively large, or mechanical properties such as strength may be degraded. If the depth DOL_TP1 of the first transition point TP1 is excessively small, a section capable of efficiently preventing the propagation of cracks due to a strong impact may be reduced. In view of the above, the depth DOL_TP1 of the first transition point TP1 according to some exemplary embodiments may be in the range of about 6 μm to about 14.5 μm. The depth DOL_TP1 of the first transition point TP1 according to another exemplary embodiment may be in the range of about 8 μm to about 12.5 μm. The depth DOL_TP1 of the first transition point TP1 according to still another exemplary embodiment may be in the range of about 9.5 μm to about 10.5 μm.

The ratio of the depth DOL_TP1 of the first transition point TP1 to the first compression depth DOC1 may be in the range of about 0.075 to about 0.084, or may be in the range of about 0.079 to about 0.080.

If the stress CS_TP1 of the first transition point TP1 is excessively large, the compressive energy increases or the depth of the first transition point TP1 becomes small, which makes it difficult to prevent the propagation of cracks. If the stress CS_TP1 of the first transition point TP1 is excessively small, the strength may become excessively small. From this perspective, the stress CS_TP1 of the first transition point TP1 may be in the range of about 70 MPa to about 150 MPa. The stress CS_TP1 of the first transition point TP1 may range from about 0.067 times to about 0.144 times the compressive stress CS1, or may range from about 0.080 times to about 0.120 times on the first surface US.

Similarly to the third feature point, the fourth feature point is located at a predetermined depth and has a predetermined stress value. The first′ transition point TP1′ represented by the fourth feature point is deeply associated with the second slope m₂ of the second segment SG2 and the third slope m₃ of the third segment SG3. The second slope m₂ may be determined by process conditions of the second ion exchange process and the stress relieving process, and the third slope m₃ may be determined by process conditions of the third ion exchange process.

The x-coordinate value (depth) of the first′ transition point TP1′ has a value between 0 and the first transition point TP1, and the y-coordinate value (stress) of the first′ transition point TP1′ has a value between the compressive stress CS_TP1 at the first transition point TP1 and the maximum compressive stress CS1. In an exemplary embodiment, the depth of the first′ transition point TP1′ from the first surface US may be about 9.5 μm or less, and the stress at the first′ transition point TP1′ may be about 150 MPa or more and about 1,000 MPa or less.

Since the x-coordinate value (depth) of the first′ transition point TP1′ is very small, unlike the first transition point TP1, it may not influence the magnitude of the compressive energy of the first compressive region CSR1. That is, the first′ transition point TP1′ is located at a very shallow depth from the first surface US, and the stress at the first′ transition point TP1′ may be similar to the compressive stress CSK at the first surface US of the glass that has undergone the second ion exchange process.

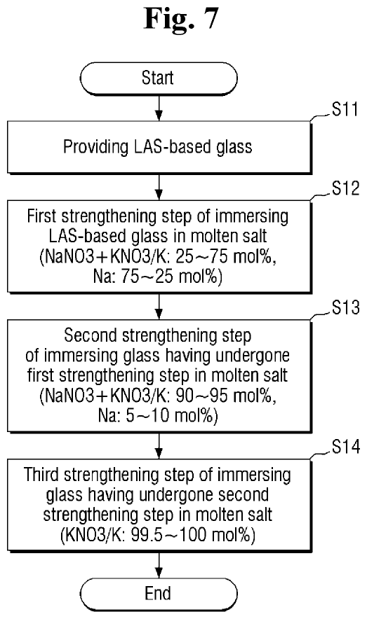

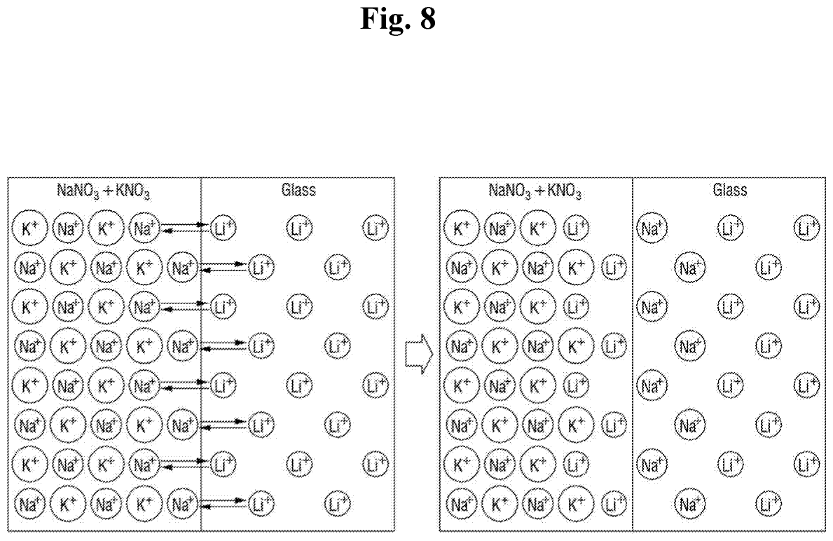

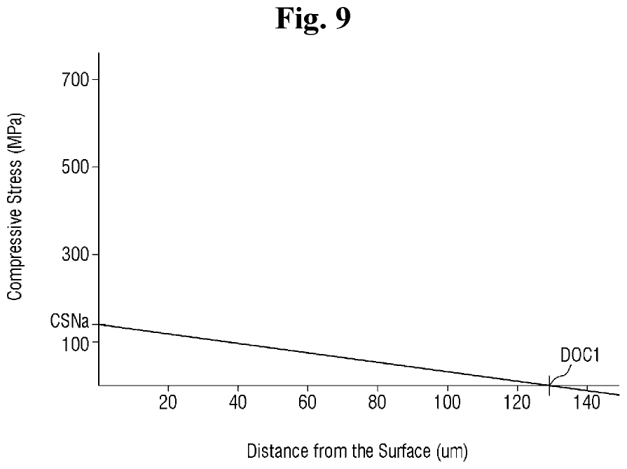

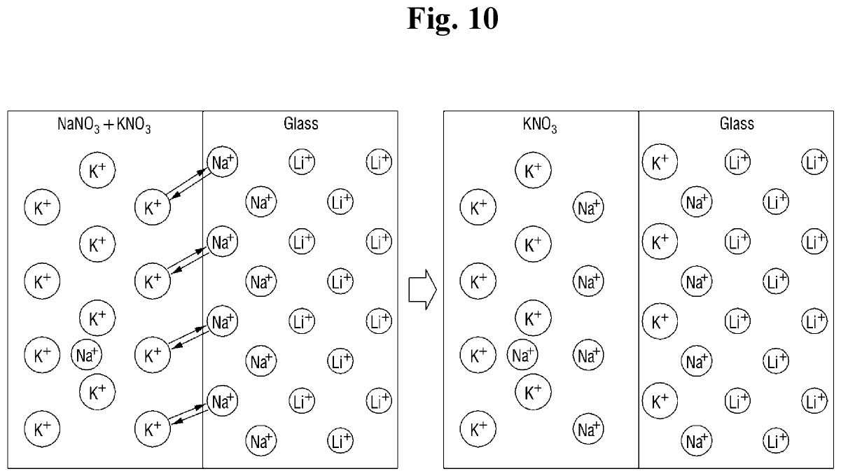

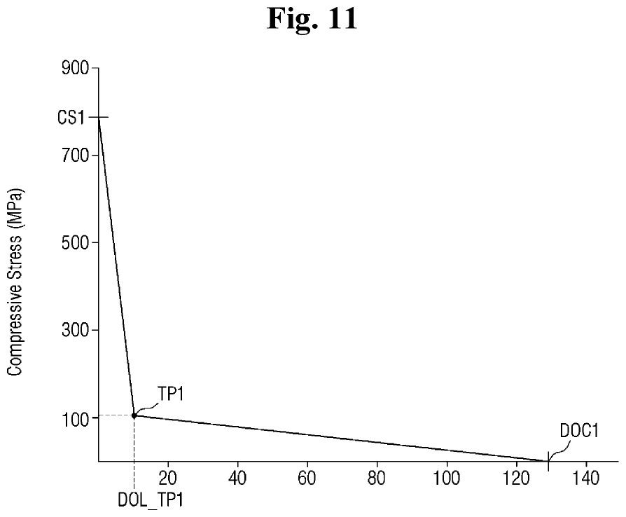

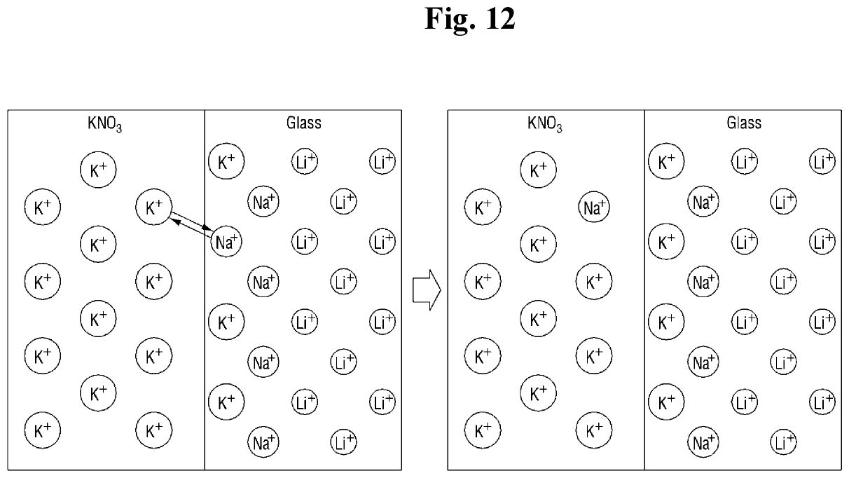

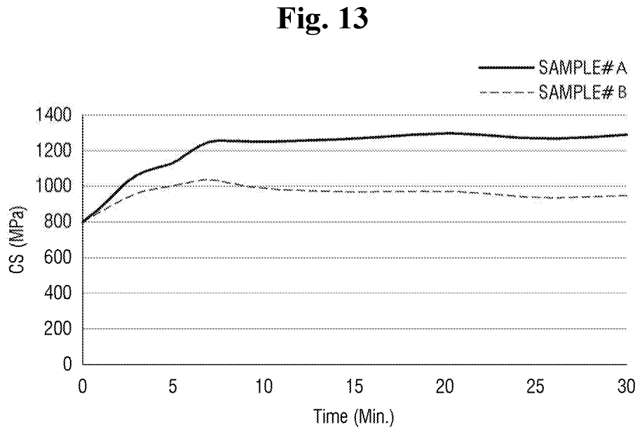

FIG. 7 is a flowchart of an exemplary embodiment of a method for manufacturing a glass article according to principles of the invention. FIG. 8 is a schematic diagram illustrating an exemplary embodiment of an ion exchange process of a first strengthening step in the method for manufacturing the glass article of FIG. 7. FIG. 9 is a graphical depiction showing the stress profile of the glass article after having undergone the first strengthening step. FIG. 10 is a schematic diagram illustrating an exemplary embodiment of an ion exchange process of a second strengthening step in the method for manufacturing the glass article of FIG. 7. FIG. 11 is a graphical depiction showing the stress profile of the glass article after having undergone the second strengthening step. FIG. 12 is a schematic diagram illustrating an exemplary embodiment of an ion exchange process of a third strengthening step in the method for manufacturing the glass article of FIG. 7. FIG. 13 is a graphical depiction showing the maximum compressive stress of a glass article changing over time during the ion exchange process of the third strengthening step.

Hereinafter, a method of manufacturing the glass article 100 according to an exemplary embodiment will be described with reference to FIGS. 7 to 13.

Referring to FIG. 7, a method for manufacturing the glass article 100 according to an exemplary embodiment may include providing LAS-based glass (step S11), a first strengthening step (S12) of immersing the LAS-based glass in molten salt (NaNO₃+KNO₃; K: about 25 to about 75 mol %, Na:about 75 to about 25 mol %, based on the total number of moles of cations in the first molten salt), a second strengthening step (step S13) of immersing the glass having undergone the first strengthening step in molten salt (NaNO₃+KNO₃; K:about 90 to about 95 mol %, Na:about 5 to about 10 mol %, based on the total number of moles of cations in the second molten salt), and a third strengthening step (S14) of immersing the glass having undergone the second strengthening step in molten salt (KNO₃; K:about 99.5 to about 100 mol %, based on the total number of moles of cations in the third molten salt).

The step S11 of providing LAS-based glass may include preparing a glass composition and molding the glass composition.

The glass composition has a silicon dioxide (SiO₂) as a main component. In addition, it may contain components such as an aluminum oxide (Al₂O₃), a lithium oxide (LiO₂) and a sodium oxide (Na₂O), but is not limited thereto, and may further include other components as necessary. In one exemplary embodiment, the glass composition of the LAS-based glass may include glass ceramics including a lithium aluminosilicate. In an exemplary embodiment, a silicon dioxide (SiO₂) may be included in the range of about 55 mol % to about 62 mol %, an aluminum oxide (Al₂O₃) may be included in the range of about 18 mol % to about 26 mol %, a sodium oxide (Na₂O) may be included in the range of about 8 mol % to about 13 mol %, a lithium oxide (LiO₂) may be included in the range of about 2 mol % to about 5 mol %, based on oxide, but is not limited thereto.

The glass composition described above may be molded into a generally plate glass shape by various methods known in the art. For example, it may be molded by a float process, a fusion draw process, a slot draw process, or the like. Hereinafter, the first to third strengthening steps S12, S13 and S14 will be described.

Referring to FIGS. 7 to 9, the first strengthening step S12 includes a first ion exchange process in which a LAS-based glass is immersed in a first molten salt. The first molten salt may contain sodium nitrate (NaNO₃) and potassium nitrate (KNO₃), the concentration of sodium (Na) ions in the cations of the molten salt may be about 75 mol % to about 25 mol %, and the concentration of potassium (K) ions in the cations of the molten salt may be about 25 mol % to about 75 mol % based on the total number of moles of cations in the first molten salt. The first ion exchange process may be performed for about 90 minutes to about 240 minutes at a temperature range of about 385° C. to about 405° C.

The first ion exchange process indicates that lithium (Li) ions on the glass surface are exchanged for sodium (Na) ions. When the glass containing lithium (Li) ions is exposed to sodium (Na) ions by immersing it in a molten salt bath containing sodium nitrate (NaNO₃), lithium (Li) ions on the glass surface may be discharged to the outside and may be replaced by sodium (Na) ions. Because the exchanged sodium (Na) ions have a larger ionic radius than the lithium (Li) ions, it may generate compressive stress. The greater the amount of sodium (Na) ions exchanged, the greater the compressive stress. Therefore, the ion exchange process according to the embodiment of FIG. 7 may be the first strengthening step (S12).

The molten salt used in the first ion exchange process may be mixed molten salt containing sodium nitrate (NaNO₃) and potassium nitrate (KNO₃). The initial content of cations of the molten salt used in the first ion exchange process may include about 75 mol % to about 25 mol % of sodium (Na) ions and about 25 mol % to about 75 mol % of potassium (K) ions based on the total number of moles of cations in the first molten salt. The first ion exchange process may be performed at a temperature of about 385° C. to about 405° C. (e.g., about 395° C.) for about 90 minutes to about 240 minutes (e.g., about 165 minutes). As the first ion exchange process proceeds, lithium (Li) ions may be eluted from the inside of the glass, and the content of sodium (Na) ions in the mixed molten salt may be substantially reduced.

Because the exchanged sodium (Na) ions have a larger ionic radius than the lithium (Li) ions, they may generate compressive stress. The greater the amount (i.e., density) of sodium (Na) ions exchanged, the greater the compressive stress. Since the ion exchange takes place through the surface of the glass, the amount (density) of sodium (Na) ions on the glass surface is the greatest. Although some of the exchanged sodium (Na) ions may diffuse into the glass to increase the compression depth, the amount (density) may generally decrease as it goes away from the surface.

The sodium (Na) ions exchanged in the first ion exchange process may diffuse to a depth equal to or smaller than the first compression depth DOC1. The amount (density) of sodium (Na) ions may generally decrease as it goes away from the surface. As the amount (density) of sodium (Na) ions increases, the compressive stress may increase. The glass that has undergone the first ion exchange process has a maximum compressive stress CSNa at the first surface US, and the compressive stress may decrease as it goes into the glass. Accordingly, when moving from the first surface US of the glass to the first compression depth DOC1, the stress profile may appear in which the compressive stress decreases. However, the exemplary embodiments are not limited to the above examples. The stress profile may be modified depending on the temperature, time, number of times, presence or absence of heat treatment and/or the like of the ion exchange process.

Referring to FIGS. 7, 10 and 11, the second strengthening step (S13) includes a second ion exchange process in which the glass subjected to the first strengthening step is immersed in a second molten salt. The second molten salt may contain sodium nitrate (NaNO₃) and potassium nitrate (KNO₃), the content of sodium (Na) ions in the cations of the molten salt may be about 5 mol % to about 10 mol %, and the content of potassium (K) ions in the cations of the molten salt may be about 90 mol % to about 95 mol % based on the total number of moles of cations in the second molten salt. The second ion exchange process may be performed for about 30 minutes to about 120 minutes at a temperature of about 370° C. to about 390° C.

When the glass containing sodium (Na) ions is exposed to potassium (K) ions by immersing it in a mixed molten salt bath containing potassium nitrate (KNO₃) and sodium nitrate (NaNO₃), sodium (Na) ions in the glass are discharged to the outside and the potassium (K) ions may replace them. Because the exchanged potassium (K) ions have a larger ionic radius than the sodium (Na) ions, it may generate compressive stress. The greater the amount of potassium (K) ions exchanged, the greater the compressive stress. Therefore, the ion exchange process according to the embodiment of FIG. 10 may be the second strengthening step (S13).

The molten salt used in the second ion exchange process may contain sodium nitrate (NaNO₃) and potassium nitrate (KNO₃). The initial content of cations in the second molten salt may be about 5 mol % to about 10 mol % of sodium (Na) ions, and about 90 mol % to about 95 mol % of potassium (K) ions based on the total number of moles of cations in the second molten salt. The second ion exchange process may be performed at a temperature of about 370° C. to about 390° C. (e.g., about 380° C.) for about 30 minutes to about 120 minutes (e.g., about 75 minutes). As the second ion exchange process proceeds, sodium (Na) ions may be eluted from the inside of the glass, and the content of potassium (K) ions in the molten salt may decrease.

In the ion exchange process, the maximum compressive stress CS1 of the glass article 100 may change according to a change in the content of potassium (K) ions in the mixed molten salt. The glass that has undergone the ion exchange process with molten salt including about 98 mol % of potassium (K) ions may have a significantly lower maximum compressive stress CS1 than when using molten salt including about 100 mol % of potassium (K) ions. However, the glass subjected to the ion exchange process with molten salt including about 92 mol % of potassium (K) ions may have the maximum compressive stress CS1 similar to that when using molten salt including about 98 mol % of potassium (K) ions.

Therefore, if the ion exchange process is repeatedly performed using molten salt including about 100 mol % of potassium (K) ions in the mass production process, the dispersion of the maximum compressive stress CS of the initially produced glass and the subsequently produced glass may increase. In order to make small the dispersion of the maximum compressive stress of the glass, when performing the second ion exchange process, it may be desirable to use mixed molten salt including sodium nitrate (NaNO₃) having about 5 mol % to about 10 mol % of sodium (Na) ions and potassium nitrate (KNO₃) having about 90 mol % to about 95 mol % of potassium (K) ions based on the total number of moles of cations in the second molten salt. When performing the second ion exchange process, the maximum compressive stress CS of the glass may be about 600 MPa to about 900 MPa.

The compressive stress of the glass subjected to the second ion exchange process may have the largest value CSK at the first surface US and may decrease as it goes toward the inside. In the stress profile of the glass, the absolute value of the slope of the region between the first surface US and the first transition point TP1 may have a value greater than the absolute value of the slope of the region between the first transition point TP1 and the first compression depth DOL1. That is, when proceeding from the first surface US of the glass subjected to the second ion exchange process to the first compression depth DOL1, the stress profile may appear in which the absolute value of the slope decreases at the first transition point TP1.

The maximum compressive stress CSK of the glass subjected to the second ion exchange process may be about 700 MPa to about 890 MPa (e.g., about 775.8 MPa), the depth of the first transition point TP1 may be about 8 μm to about 12.5 μm (e.g., about 10.2 μm), the compressive stress at the first transition point TP1 may be about 70 MPa to about 150 MPa (e.g., about 103.3 MPa), the tensile stress CT at the center may be about 87 MPa or less (e.g., about 63.8 MPa), and the first compression depth DOL1 may be about 120 μm to about 140 μm (e.g., about 127.3 μm). The first compression depth DOL1 may be equal to a first ion exchange depth DOLNa.

The compressive energy may be additionally formed by the second ion exchange process. When the compressive stress is additionally formed through the second ion exchange process, the tensile energy of the same magnitude as the compressive energy additionally formed according to Mathematical Expression 1 may be accumulated in the glass.

Referring to FIGS. 7, 12 and 13, the third strengthening step (S14) includes a third ion exchange process in which the glass subjected to the second strengthening step is immersed in third molten salt. The third molten salt includes potassium nitrate (KNO₃), and the concentration of potassium (K) ions in the cations of the molten salt may be about 99.5 mol % to about 100 mol %. The third ion exchange process may be performed for about 5 minutes to about 10 minutes at a temperature of about 370° C. to about 390° C.

In the ion exchange process of the second strengthening step, sodium (Na) ions inside the glass that are not exchanged may be exchanged for potassium (K) ions. The ion exchange process may be performed on the first, second and side surfaces (US, RS and SS) of the glass.

When exposed to potassium (K) ions, for example, by immersing the glass containing sodium (Na) ions, which has undergone the second ion exchange process, in a molten salt bath containing potassium nitrate (KNO₃), sodium (Na) ions that are not exchanged in the second ion exchange process are discharged to the outside and potassium (K) ions may replace them. That is, sodium (Na) ions present near the surfaces US, RS and SS of the glass during the third ion exchange process may be exchanged with potassium (K) ions. As described above, since the potassium (K) ions have a larger ionic radius than the sodium (Na) ions, it may generate compressive stress. The greater the amount of potassium (K) ions exchanged, the greater the compressive stress. Therefore, the ion exchange process according to the embodiment of FIG. 12 may be the third strengthening step.

The molten salt used in the third ion exchange process may be single molten salt containing potassium nitrate (KNO₃). The initial content of cations in the molten salt used in the third ion exchange process may include about 99.5 mol % to about 100 mol % of potassium (K) ions based on the total number of moles of cations in the third molten salt. The third ion exchange process may be performed at a temperature of about 370° C. to about 390° C. (e.g., about 395° C.) for about 5 minutes to about 10 minutes (e.g., about 7 minutes). As the third ion exchange process proceeds, sodium (Na) ions may be eluted from the inside of the glass, and the concentration of potassium (K) ions in the molten salt may substantially decrease.

When performing the third ion exchange process, the maximum compressive stress of the glass article 100 may be about 1,000 MPa to about 1,300 MPa. The potassium nitrate (KNO₃) molten salt having about 99.5 mol % to about 100 mol % of potassium (K) ions based on the total number of moles of cations in the third molten salt used in the third ion exchange process may be used multiple times. The molten salt may be used up to about 30 times when considering a reduction in the content of potassium (K) ions due to sodium (Na) ions eluting from the inside of the glass during the third ion exchange process, but the exemplary embodiments are not limited thereto. In an exemplary embodiment, the third strengthening process may further include replacing the molten salt used in the third ion exchange process with new molten salt about every 30 times of repeated use.

The upper graph of FIG. 13 shows a change in the maximum compressive stress over time when the third strengthening step was performed using molten salt containing potassium nitrate (KNO₃) having about 99.5 mol % to about 100 mol % of potassium (K) ions based on the total number of moles of cations in the third molten salt. As the third ion exchange process proceeds, the maximum compressive stress value may increase. In one exemplary embodiment, the maximum compressive stress may saturate between about 5 minutes and about 10 minutes of the third ion exchange process time. In another exemplary embodiment, the maximum compressive stress may saturate between about 6 minutes and about 9 minutes of the third ion exchange process time. In still another exemplary embodiment, the maximum compressive stress may saturate between about 7 minutes and about 8 minutes of the third ion exchange process time.

The lower graph of FIG. 13 shows a change in the maximum compressive stress over time when the third strengthening step was performed using molten salt obtained by repeatedly performing the third strengthening step about 30 times with molten salt containing potassium nitrate (KNO₃) having about 99.5 mol % to about 100 mol % of potassium (K) ions. As the third ion exchange process proceeds, the maximum compressive stress value may increase. In one exemplary embodiment, the maximum compressive stress may be saturated between about 3 minutes and about 10 minutes of the ion exchange process time. In another exemplary embodiment, the maximum compressive stress may be saturated between about 4 minutes and about 9 minutes of the ion exchange process time. In still another exemplary embodiment, the maximum compressive stress may be saturated between about 5 minutes and about 8 minutes of the ion exchange process time.

TABLE 1

| | Initial molten salt | Molten salt used 30 times |
|---|---|---|
| Time (Min.) | CS (MPa) | CS (MPa) |
| 0 | 797.6 | 797.6 |
| 1 | 879.7 | 854.6 |
| 3 | 1060.2 | 959.2 |
| 5 | 1131.2 | 1001.9 |
| 7 | 1247.4 | 1033.6 |
| 10 | 1248.1 | 986.6 |
| 15 | 1266.8 | 965.2 |
| 20 | 1296.7 | 969.4 |
| 25 | 1266.8 | 935.0 |
| 30 | 1288.3 | 944.8 |

Specifically, referring to Table 1 above, in the case of using molten salt containing a potassium nitrate (KNO₃) solution having about 99.5 mol % to about 100 mol % of potassium (K) ions based on the total number of moles of cations in the third molten salt during the third ion exchange process, the maximum compressive stress increased from about 797.6 MPa to about 1247.4 MPa during the process time of about 0 to about 7 minutes, but when it exceeds about 7 minutes, the maximum compressive stress hardly changes over time, and may have a value in the range of about 1247.4 MPa to about 1296.7 MPa. That is, when the third ion exchange process time exceeds about 7 minutes, the maximum compressive stress may reach a saturation state.

When using molten salt with a reduced concentration of potassium (K) ions obtained by repeatedly performing the third ion exchange process about 30 times with molten salt containing a potassium nitrate (KNO₃) solution having about 99.5 mol % to about 100 mol % of potassium (K) ions based on the total number of moles of cations in the third molten salt, the maximum compressive stress increased from about 797.6 MPa to about 1033.6 MPa during the process time of about 0 to about 7 minutes, but when it exceeds about 7 minutes, the maximum compressive stress may decrease and have a constant value in the range of about 935.0 MPa to about 986.6 MPa. Therefore, the maximum compressive stress that can be formed during the third ion exchange process may have a value in the range of about 986.6 MPa to about 1248.1 MPa.

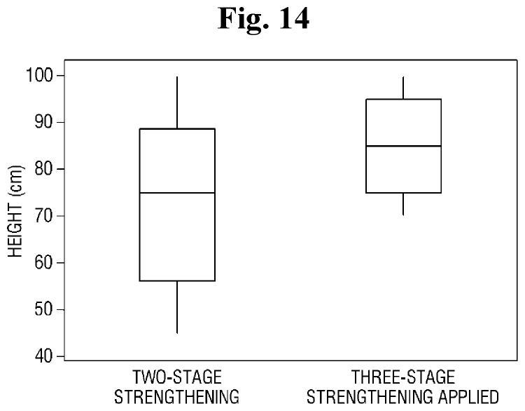

FIG. 14 is a graphical depiction showing glass impact test (GIT) results of a glass article with and without applying the third strengthening step.

A plurality of plate-shaped glass substrates having a lithium aluminosilicate composition were prepared, and Sample Group #A subjected to two-stage chemical strengthening and Sample Group #B subjected to three-stage chemical strengthening were prepared by varying the chemical strengthening order, respectively.

Glass impact test (GIT) evaluation was performed using Sample Groups #A and #B. For the GIT evaluation, 10 samples were prepared for each of Sample Groups #A and #B. GIT evaluation was performed by placing and fixing a strengthened glass sample on a ring, and then dropping a 60 g ball onto the surface of the sample to check the height at which the sample is broken. If a crack did not occur when dropping the ball, the ball drop was repeated by increasing the height by 5 cm. Finally, when a crack occurred, the height (i.e., the maximum height at which no crack occurred) immediately before the occurrence of the crack was determined as the critical drop height. In the GIT test, it is determined that the higher the critical drop height at which the glass sample is broken, the higher the strength of the glass sample.

The left graph of FIG. 14 shows the results obtained by performing a GIT test using a sample subjected to two-stage strengthening on LAS-based glass. The right graph of FIG. 14 shows the results obtained by performing a GIT test using a sample subjected to three-stage strengthening on LAS-based glass. Table 2 shows an average value (ave), a minimum value (min) and a maximum value (max) of the critical drop height for each sample group.

TABLE 2

| | | |
|---|---|---|
| # | Sample Group #A | Sample Group #B |

| | | | | |
|---|---|---|---|---|
| Ave | 74.75 | cm | 85 | cm |
| Min | 45 | cm | 70 | cm |
| Max | 100 | cm | 100 | cm |

Referring to Table 2 above, the critical drop height of Sample Group #A subjected to two-stage strengthening exhibited a relatively large distribution in the range of about 45 cm to about 100 cm, and the average value thereof was about 74.75 cm. On the other hand, the critical drop height of Sample Group #B subjected to three-stage strengthening exhibited a relatively small distribution in the range of about 70 cm to about 100 cm, and the average value thereof was about 85 cm. As a result of the GIT test, it can be seen that Sample Group #B to which three-stage strengthening was applied exhibited significantly and surprisingly improved strength of the glass article and a smaller strength distribution than Sample Group #A to which the two-stage strengthening was applied.

Although certain exemplary embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A method for manufacturing a glass article for a display device, the method comprising:
providing a LAS-based glass;
a first step of immersing the LAS-based glass in a first molten salt;
a second step of immersing the LAS-based glass subjected to the first step in a second molten salt; and
a third step of immersing the LAS-based glass subjected to the second step in a third molten salt,
wherein a concentration in the first molten salt of first cations ranges from about 75 mol % to about 25 mol %, and a concentration of second cations ranges from about 25 mol % to about 75 mol %, based on the total number of moles of cations in the first molten salt,
wherein a concentration in the second molten salt of first cations ranges from about 5 mol % to about 10 mol %, and a concentration of second cations ranges from about 90 mol % to about 95 mol %, based on the total number of moles of cations in the second molten salt
wherein a concentration in the third molten salt of second cations ranges from about 99.5 mol % to about 100 mol % based on the total number of moles of cations in the third molten salt, and
wherein the third step is performed for about 5 minutes to about 10 minutes.

2. The method of claim 1, wherein the first cations have a size smaller than that of the second cations.

3. The method of claim 2, wherein the first cations comprise sodium ions, and the second cations comprise potassium ions.

4. The method of claim 1, wherein the first step comprises a first strengthening step performed for about 90 minutes to about 240 minutes at a temperature of about 385° C. to about 405° C.

5. The method of claim 1, wherein the second step comprises a second strengthening step performed for about 30 minutes to about 120 minutes at a temperature of about 370° C. to about 390° C.

6. The method of claim 1, wherein the third step comprises a third strengthening step performed at a temperature of about 370° C. to about 390° C.

7. The method of claim 1, wherein each of the first molten salt and the second molten salt comprises at least one of sodium nitrate and potassium nitrate, and
wherein the third molten salt comprises potassium nitrate.

8. The method of claim 1, wherein the LAS-based glass subjected to the first to third steps has a maximum compressive stress in a range of about 986.6 MPa to about 1248.1 MPa.

9. The method of claim 8, the strengthened LAS-based glass has a stress profile including at least four inflection points.

10. The method of claim 8, wherein the strengthened LAS-based glass has a compression depth of about 120 μm to about 130 μm.

11. The method of claim 8, wherein the strengthened LAS-based glass has an average value of a critical drop height, which ranges from about 70 cm to about 100 cm, in a glass impact test (GIT) evaluation using a ball of 60 g for 10 or more samples.

12. The method of claim 1, wherein the LAS-based glass comprises a silicon dioxide in a range of about 55 mol % to about 62 mol %, an aluminum oxide in a range of about 18 mol % to about 26 mol %, a sodium oxide in a range of about 8 mol % to about 13 mol %, and a lithium oxide in a range of about 2 mol % to about 5 mol %; based on oxide.

13. The method of claim 1, wherein the third molten salt is used multiple times, and the third step further includes replacing the third molten salt about every 30 times of repeated use.

14. A glass article for a display device, the glass article containing lithium aluminosilicate and, comprising:
a first surface;
a second surface opposed to the first surface;
a first compressive region extending from the first surface to a first compression depth;
a second compressive region extending from the second surface to a second compression depth; and
a tensile region disposed between the first compression depth and the second compression depth,
wherein the first compressive region has a stress profile including a first segment located between the first compression depth and a first transition point, a second segment located between the first transition point and a first′ transition point, and a third segment located between the first′ transition point and the first surface,
wherein the first surface has a stress ranging from about 986.6 MPa to about 1248.1 MPa,
wherein the first compression depth ranges from about 120 μm to about 140 μm,
wherein a depth from the first surface to the first transition point ranges from about 9.5 μm to about 10.5 μm, and
wherein at the first transition point has a stress ranging from about 70 MPa to about 150 MPa.

15. The glass article of claim 14, wherein a depth from the first surface to the first′ transition point is about 9.5 μm or less, and
wherein the first′ transition point has a stress ranging from about 150 MPa to about 1000 MPa.

16. The glass article of claim 14, wherein a depth of the first transition point is about 0.075 times to about 0.084 times the first compression depth.

17. The glass article of claim 14, wherein the stress at the first transition point is about 0.08 times to about 0.12 times the stress at the first surface.

18. The glass article of claim 14, wherein an absolute value of an average slope of the second segment is greater than an absolute value of an average slope of the first segment, and
wherein an absolute value of an average slope of the third segment is greater than the absolute value of the average slope of the second segment.

19. The glass article of claim 18, wherein the absolute value of the average slope of the first segment has a value in a range of about 0.9 to about 1.05,
wherein the absolute value of the average slope of the second segment has a value in a range of about 1.05 to about 93, and
wherein the absolute value of the average slope of the third segment has a value greater than about 93.

20. The glass article of claim 14, wherein the glass article has an average value of a critical drop height, which ranges from about 70 cm to about 100 cm, in a glass impact test (GIT) evaluation using a ball of 60 g for 10 or more samples.
